(19) United States
(12) Patent Application Publication
(10) Pub. No.: US 2005/0110190 A1
(43) Pub. Date: May 26, 2005

(54) Process for making a membrane for fluid-control apparatuses, and membrane made thereby

(76) Inventors: Edo Giardini, Arcore (IT); Luca Panzeri, Lomagna (IT)

Correspondence Address: BROWDY AND NEIMARK, P.L.L.C.;624 NINTH STREET, NW, SUITE 300, WASHINGTON, DC, 20001-5303, US

(21) Appl. No.: 10/947,662

(22) Filed: Sep. 23, 2004

(30) Foreign Application Priority Data
Sep. 26, 2003 (EP) 03425624.8

(51) Int. Cl. B29C 45/14; B32B 27/32

(52) U.S. Cl. 264/259; 264/266; 428/480; 428/523

(57) ABSTRACT

It is disclosed a process comprising the steps of making the first layer of a membrane with a first plastic material chemically compatible with the fluid to be treated, making a second layer of a second plastic material defining the mechanical performance of the membrane and coupling said layers, the process consisting in: inserting a first plastic material selected from polyolefines, polyamides, polyesters, vinyl resins into a moulding cavity (2) and injection-moulding at least one second plastic material defined by a thermoplastic elastomer (TPE) in said moulding cavity (2) to form at least one second layer (8) directly joined to the first layer (7).

The invention relates to a process for making a membrane for fluid-control apparatuses, and the membrane obtained with said process, as set forth in the preamble of claim 1.

The membrane or diaphragm is for example of the type to be used in pumps, compressors, pressure regulators, volume meters, valves.

It is known that membranes of the above kind are provided in many cases for delivering, metering or directing fluids such as liquids that may also be of the corrosive and/or polluting type.

Therefore, these membranes must be chemically compatible with these fluids and simultaneously they can be relied on to last a long time and be flexible and strong.

Said different requirements are met in most cases by arranging membranes of the stratified type and having a first layer of a material resistant to chemical agents and a second layer of a material of appropriate mechanical strength, duration and flexibility.

The first layer is typically made of a fluorinated resin such as polytetrafluoroethylene (PTFE) marked with the trademark Teflon® and available from Du Pont.

Polytetrafluoroethylene (PTFE) is preferred due to its great capability of resisting to chemical agents of various types, its tendency not to adhere to the treated materials and fluids and also due to the very reduced coefficient of friction it shows towards the treated fluids.

The second layer is made of various materials and is set with a greater thickness than that of the first layer.

The two layers are disposed in side by side relationship and adhere to each other: the first layer is placed on the membrane side that is in contact with the fluid to control, the second on the other side that is protected by the first one. The above mentioned known art enables membranes or diaphragms to be made of appropriate functional features, but it has some important drawbacks.

In fact, preparation of said layers is arduous and very expensive: they must all be preformed or shaped in a precise manner and joined together.

In particular, preforming of the first layer, selected for being adapted to chemically resist reactive/corrosive fluids, and above all gluing of the first layer to the second layer through special adhesives or bonding agents, is difficult and expensive.

In fact, it is necessary to join materials that are very different from each other, although they all consist of plastic materials, and it is necessary to do it without worsening or altering the physical and chemical features of same. In real terms, in order to succeed in joining the polytetrafluoroethylene (PTFE) or Teflon®—that is distinguishable due to its tendency not to adhere to other materials—to another plastic material, special bonding agents are required—Chemlock® available from Lord Corporation of Eire, for example—as well as special procedures to couple the layers in the presence of the bonding agent and preventing the same from losing their physical and chemical properties.

Costs for these operations are so high that attempts have been also made to avoid gluing and merely dispose the layers close to each other.

In fact, some membranes have a first layer of Teflon® (PTFE) that is merely disposed tightly close to or pressed against another plastic material.

It is however apparent that a membrane with the layers joined together can be relied on to a greater extent in terms of reliability and mechanical duration and in particular reduces seepage of the treated fluid between the membranes and therefore corrosion of the second layer that is unsuitable to resist chemical agents or polluting substances.

There is therefore an unresolved technical problem consisting in how to make reliable membranes at low costs.

Under this situation the technical task underlying the present invention is to conceive a process and a membrane capable of obviating the mentioned drawbacks and solving said technical problem.

The technical task is achieved by a process for making a membrane for fluid-control apparatuses and by a membrane obtained with said process, as claimed in the appended Main claims.

Preferred embodiments are shown in the Sub-claims.

Further features and advantages of the invention will become more apparent from the following detailed description of some preferred embodiments of the invention, with reference to the accompanying drawings, in which:

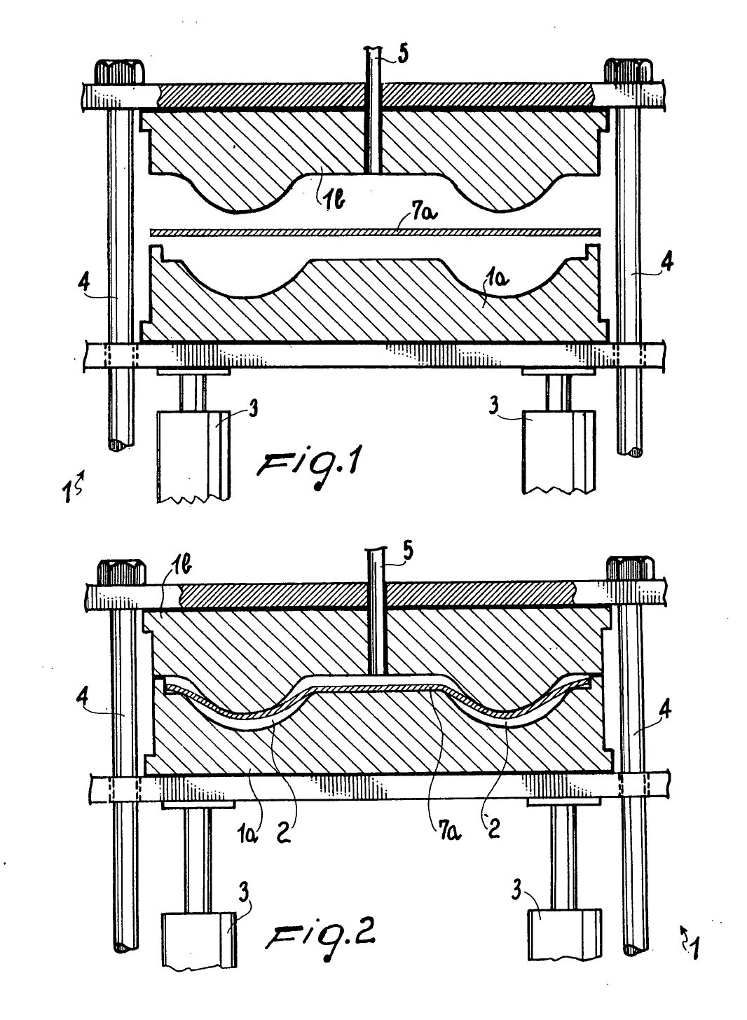

FIG. 1 shows a first step of carrying out the process in accordance with the invention, with insertion of a first laminar and not preformed plastic material between a mould and a countermould in an open position;

FIG. 2 shows a second step of the process, in which the mould and countermould are closed on the first plastic material;

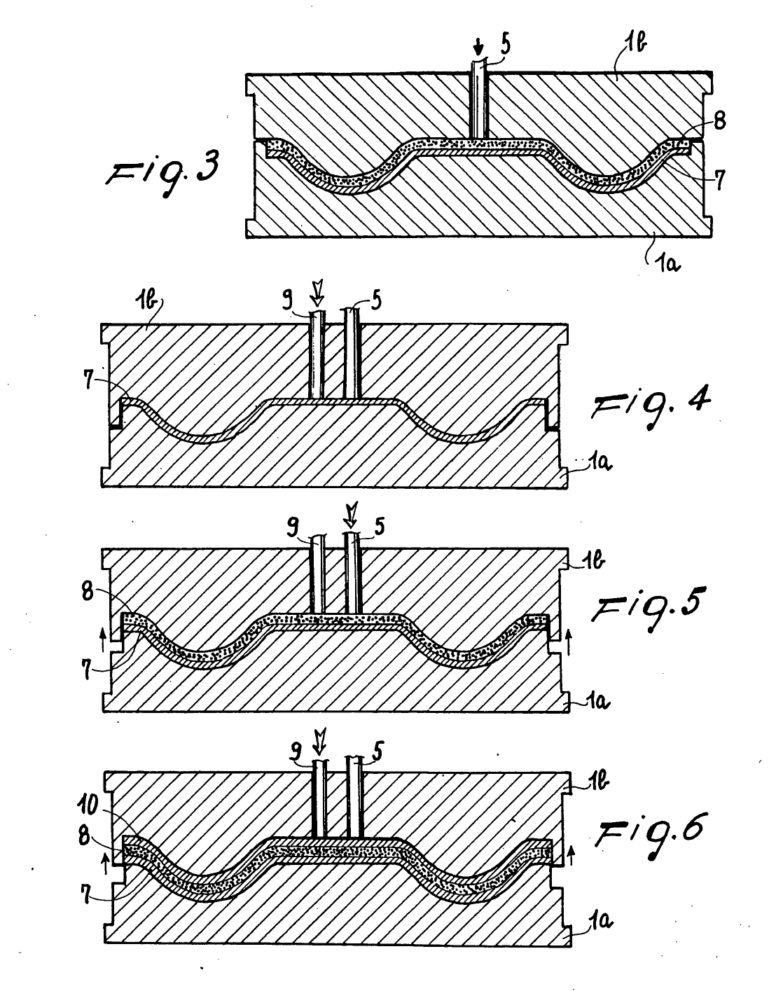

FIG. 3 shows a third step in which a second plastic material is injected;

FIG. 4 is a further embodiment of the process in a first step during which a first layer is moulded;

FIG. 5 shows a subsequent step to that seen in FIG. 4;

FIG. 6 shows a further step, subsequent to that in FIG. 5;

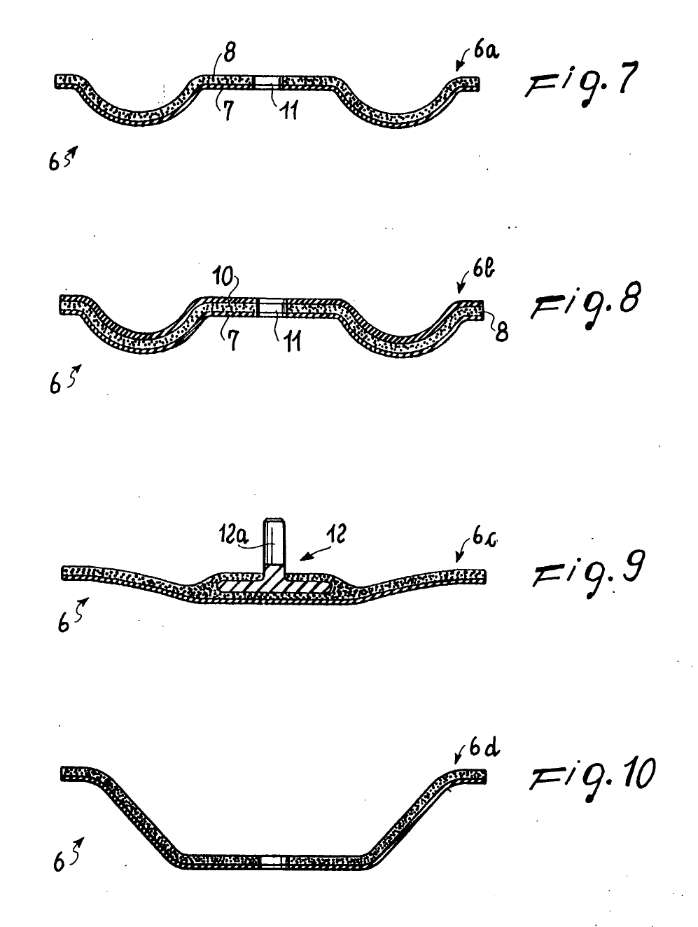

FIG. 7 is a section view of a membrane made up of two layers obtained with the process shown in FIGS. 1 to 3, provided with a central opening;

FIG. 8 is a section view of a membrane similar to that in FIG. 7 but consisting of three layers and obtained with the process seen in FIGS. 4 to 6;

FIG. 9 shows a two-layer membrane provided with a substantially flattened shape and centrally having a metal insert; and

FIG. 10 shows a substantially cup-shaped two-layer membrane.

In accordance with the invention, it is provided a process comprising a plurality of steps carried out after arrangement of at least one moulding unit 1 including at least one mould 1a and a related countermould 1b defining at least one moulding cavity 2 between each other.

FIGS. 1 and 2 diagrammatically show a moulding unit 1 in which movements between mould 1a and countermould 1b close to and away from each other are driven by pistons 3 and guided by dowel and guide pins 4.

At least one first injector 5 is provided to introduce plastic material in a melted state into the moulding cavity 2 when the mould 1a and countermould 1b are in a closed position.

In the preferred embodiment shown in FIGS. 1 to 3 the moulding cavity 2 has substantially fixed sizes and shape corresponding to the final sizes and shape of the membrane to be made. Said membrane taken as a whole is generally denoted at 6 while 6a specifically identifies the membrane obtained with the process referred to in FIGS. 1 to 3.

The membrane or diaphragm 6 is of the stratified type as it comprises several layers of plastic material.

In accordance with a step of the process, at least one first plastic material is provided to be inserted in the moulding cavity 2, which plastic material is of a type chemically compatible with the fluid to be treated, i.e. capable either of resisting the chemically reactive elements present in the fluid—generally a liquid —that the membrane 6 must control or treat, or of withstanding without damages the polluting substances present in the fluid or the dirtiness resulting from treatment of staining fluids.

Said first plastic material is in fact the material designed to make at least one first layer 7 of the membrane 6 that is directly set in contact with said fluid.

The first plastic material is selected from special thermoplastic materials having features of resistance to chemical agents: polyolefines, polyamides, polyesters, vinyl resins.

Preferably a polyolefine such as polyethylene (PE) is selected and from the great variety of polyethylenes a high density polyethylene (HDPE) with an ultra high molecular weight (UHMWPE) is selected.

The high density polyethylene (HDPE) has density values δ greater than 0.940 grams per cubic centimetre and it consists of mainly linear polymethylene chains (—CH₂—CH₂—CH₂—CH₂—).

It has a great chemical inertia and in particular is chemically resistant to acids, alkaline solutions, saline solutions, water, alcohol, esters, oil, petrol. At room temperature practically it is not attackable by any reactant and is not soluble in any solvent. Only above 90° C. it can be attacked by aromatic and chlorinated solvents.

In addition, it also has optimal mechanical, technical and electric properties. Furthermore the high density polyethylene having an ultra high molecular weight (UHMWPE i.e. as above said “Ultra High Molecular Weight Poly-Ethylene”) is a particular high density polyethylene having a molecular weight higher than two million grams per mole, four or more million grams per mole for example. Among other things, it is distinguishable for an exceptional resistance to wear and a very low coefficient of friction by sliding.

The very low friction coefficient is important in order to ensure the maximum efficiency in fluid control and is similar to that of polytetrafluoroethylene (PTFE) or Teflon®) that, as well known, is minimum.

HDPE-UHMWPE polyethylene in addition has a chemical resistance still increased with respect to that of high density polyethylene with medium molecular weight (included between fifty thousand and five hundred thousand grams per mole, for example).

It also has a maximum dimensional stability up to temperatures very close to the melting temperature and a high viscosity in the melted state as well.

Presently made of high density polyethylene with an ultra high molecular weight are for example ski soles, bearings, gears, guides for moving mechanical elements.

HDPE-UHMWPE polyethylene can be obtained by extrusion, exfoliation, sintering of powders, by casting, above all it can also be injection moulded.

In a subsequent step it is provided to inject at least one second plastic material of the type to be moulded by injection into the moulding cavity 2 directly onto the first plastic material, so as to form at least one second layer 8 substantially defining the mechanical performance and duration in time of membrane 6.

The second plastic material is in fact selected depending on its properties of flexibility, mechanical resistance and resistance to fatigue and in addition it is preferably of such an amount as to form a second layer 8 of greater thickness than the first layer 7.

The capacity of resistance to chemical agents is not important because under operating conditions the second layer 8 is protected by the first layer 7.

The second plastic material consists of a thermoplastic elastomer (TPE) selected from santoprene®, pebax®, hytrel®, finaprene®, elastollan®, pibiflex®. Preferably, the selected thermoplastic elastomer (TPE) is santoprene®, trademark of the Advanced Elastomer Systems.

Santoprene® is a thermoplastic rubber that is distinguishable for its optimal mechanical properties and its easy workability, in particular because it can be easily moulded by injection.

The injection phase of the thermoplastic elastomer (TPE) directly onto the first plastic material achieves important results.

In the case shown in FIGS. 1 to 3, the first layer 7 is partly formed out of the moulding cavity 2 and is inserted into the moulding cavity 2 itself when the mould 1a and countermould 1b are in a substantially open position. In particular, the first layer is formed out of said moulding cavity in the form of a sheet or film or plate 7a substantially flattened and not shaped.

Under this situation the plate 7a is automatically thermoformed by the injection step of the second plastic material, so as to become the first layer 7 with its final shape.

However it is not to be excluded that the second layer 8 should be fully made out of the moulding cavity 2.

At all events, formation of the second layer 8 by injection of the second plastic material onto the first one gives rise to a perfect welding between the two layers 7 and 8.

Practically the first and second layers, 7 and 8, are made definitively integral with each other in the absence of intermediate gluing means.

Injection of the second plastic material onto the first is carried out following appropriate modalities compatible with a substantial integrity of the first plastic material.

In particular, injection of the second plastic material, obviously in a melted state, is carried out in a manner adapted to bring the first plastic material to temperatures that on an average are close to and lower than the melting temperature. This does not necessarily mean that the injection temperature should be very reduced: it is for example necessary to consider the moulding conditions that can be varied, the thickness of the layers and the cooling speed of the plastic material in the moulds.

Said first plastic material is then characterised by a high viscosity in the melted state and in any case it does not heat in a uniform manner.

In addition an appropriate heating of the surface in contact with the second plastic material is wished in order to join the two layers in a stable manner. The optimal temperatures and moulding conditions in any case can be easily identified by means of normal moulding tests well known by all technicians in the sector.

In carrying out the process shown in FIGS. 4 to 6, a mould 1a and a countermould 1b are arranged that are mutually movable in a plurality of moulding positions, so as to form a moulding cavity 2 of varying volume.

For example, the mould and countermould are relatively movable between a first position (FIG. 4) at which the moulding cavity 2 substantially has the shape and sizes of the first layer 7 alone, and a second position (FIG. 5) at which the moulding cavity 2 has more extended sizes.

The mould and countermould displacement is obtained through pistons 3. Under this situation the first plastic material too is inserted by injection into the moulding cavity 2 by at least one second injector 9 and therefore the first layer 7 too is integrally made in the moulding cavity 2, which will bring about a further simplification in the operations.

The second plastic material forming the second layer 8 is then injected after displacement of mould 1a and countermould 1b to said second position. In this way a membrane similar to and made with the process of FIGS. 1 to 3 and FIG. 7 and identified by 6a is obtained.

Depending on the final features wished for the membrane, the first layer can be made by means of a plate 7a inserted in the moulding cavity 2 when mould 1a and countermould 1b are in a substantially open position (FIG. 1) or alternatively the first layer 7 can be formed by injection (FIG. 4).

For example, in the case shown in FIGS. 1 to 3, the first layer 7 can be also very thin, in the order of some hundredths of a millimetre, when plate 7a is practically a film. The second layer 8 too can be very thin, in the order of some tenths of a millimetre.

With the embodiment shown in FIGS. 4 and 5 the minimum sizes of the layers are preferably bigger, to facilitate the injection operations, but they are always very reduced, in the order of one millimetre for example for the first layer 7 and some millimetres for the second layer 8.

Bigger sizes than the minimum ones can be selected with the greatest freedom and the process in accordance with the invention has a great flexibility and enables membranes adapted to the most different applications to be made.

In fact, the thickness of both layers 7 and 8 can be widely and readily varied and diversified, and the features of the plastic materials employed can be conveniently selected in view of the foreseen applications.

In addition, by providing a mould 1a and countermould 1b mutually movable, a protected membrane 6b formed of three layers and shown in FIG. 8 can also be made, in which the thermoplastic elastomer layer (TPE) is held between two thin layers of HDPE-UHMWPE polyethylene, or other materials from those listed, to protect said thermoplastic elastomer (TPE) on both sides.

It is sufficient to provide a third step for the movable moulds, in which step mould 1a and countermould 1b are further separated from each other after injection moulding of the second layer 8, and then repeat the injection moulding operation (FIG. 6) of the first plastic material to form a third layer 10 as well.

This situation is of immediate accomplishment due to the immediate repetition of the procedures for injection of the first layer 7 and reuse of the first plastic material, although the third layer 10 could also be made of a plastic material different from the first one.

A protected membrane 6b can be adapted to avoid assembling problems to a user, when the membrane has a flattened shape or when on both sides of same the presence of seepage of corrosive substances is possible.

As highlighted in the figures, the membrane 6 made with the process in accordance with the invention can have various shapes.

As shown in FIGS. 7 to 10, for example, i.e. a first membrane 6a formed of two layers and having an annular convexity (FIG. 7), a protected membrane 6b formed of three layers (FIG. 8) or also a flattened membrane 6c (FIG. 9) or a cup-shaped membrane 6d (FIG. 10).

The first membrane 6a shown in section in FIG. 7 is obtained with a moulding process as shown in FIGS. 1 to 3, or the moulding process shown in FIGS. 4 and 5, whereas the protected membrane 6b shown in section in FIG. 8 is obtained by the injection moulding process shown in FIGS. 4 to 6, still with arrangement of a central hole 11.

The central hole 11 can be already made directly in the moulding process and its function is to enable passage, coaxially with the membrane, of a stem for operation of the latter. Said drive stem can be fastened for example by means of plates tightening the membrane at opposite faces thereof.

The shape shown in FIG. 8 on the contrary is of the type including means for engagement with said drive stem: partly buried in the second layer 8—the one determining the mechanical properties of the membrane—is a mushroom-shaped element 12 provided with a tailpiece 12a to be fixed for example by screwing to said drive stem.

At all events the membrane comprises at least one first layer 7 of a first plastic material which is resistant against the chemical agents that are present in the fluid to be controlled and at least one second layer 8 of a second plastic material defining the mechanical performance of the membrane and preferably having a bigger thickness than that of the first layer.

The first plastic material forming the first layer is selected from polyolefines, polyamides, polyesters, vinyl resins and preferably and advantageously it is a polyolefine such as high density polyethylene with an ultra high molecular weight (HDPE-UHMWPE).

The second plastic material of the second layer is a thermoplastic elastomer (TPE) to be moulded by injection, and selected from santoprene®, pebax®, hytrel®, finaprene®, elastollan®, pibiflex®. Preferably it is santoprene®.

In addition, the first and second layers 7 and 8 are directly in contact with each other and are mutually integral in the absence of gluing means.

The invention achieves important advantages.

In fact it allows membranes of full liability to be manufactured in a simple manner, in which the layers are perfectly formed and joined together in a stable manner also without use of bonding agents.

In particular, high density polyethylene with an ultra high molecular weight (HDPE-UHMWPE) has appeared to be quite satisfactory in terms of chemical resistance to most of the treated fluids, minimum coefficient of friction, duration and mechanical properties.

Above all, choice of the materials, simplicity of the production cycle and absence of gluing means and operations, as well as possibility of completely avoiding thermoforming operations carried out on the layers out of the moulds lead to manufacture of membranes much cheaper as compared with known membranes in which the layers are joined to each other.

There is a great money saving: the new membranes are even ten times less expensive than the membranes where a layer of polytetrafluoroethylene (PTFE) is provided that is joined by special gluing means to another plastic material. The production cycle reaches the maximum simplicity and versatility when the moulding cavity is arranged so as to have a varying volume and all layers are directly and fully made and joined to each other in the same moulding cavity. It is therefore possible to fully avoid manufacture of membranes with layers only disposed close to each other.

Then combination of said polyethylene (HDPE-UHMWPE) with a thermoplastic elastomer (TPE) offers the maximum compatibility between the layers and the possibility of forming all layers by injection moulding.

In fact, both plastic materials can be injection moulded, thus making it possible to manufacture the whole membrane within the same moulding cavity.

The invention is susceptible of variations.

For example many layers can be made if the membrane properties are required to be increased.

This operation can be carried out either by inserting several plates 7a in the moulding unit of FIG. 1 for example, or by consecutively moulding several layers in the moulding unit of FIG. 4.

It is then pointed out that in the process in accordance with the invention the physical and chemical features and the thickness of the plastic materials forming the layers can be selected and varied depending on the foreseen uses, so as to always obtain optimal functional features.

For example, it is to be noted that the high density polyethylene itself with an ultra high molecular weight is produced with several different additives and molecular weights and there is also a wide choice in the field of thermoplastic elastomers (TPE).

1. A process for making a membrane for fluid control apparatuses, comprising the steps of making at least one first layer (7) of a membrane (6) with a first plastic material chemically compatible with said fluid, making at least one second layer (8) of a second plastic material mainly defining the mechanical performance of said membrane (6), and making said layers integral with each other,
characterised in that it consists in: arranging at least one mould (1a) and one countermould (1b) defining at least one moulding cavity (2) therebetween; inserting a first plastic material selected from polyolefines, polyamides, polyesters, vinyl resins into said moulding cavity (2); and injection-moulding a second plastic material substantially defined by a thermoplastic elastomer (TPE), directly on said first plastic material in said moulding cavity (2), to form at least one second layer (8) directly joined to said first layer (7).

2. A process as claimed in claim 1, wherein said first plastic material is a polyolefine such as high density polyethylene (HDPE) with an ultra high molecular weight (UHMWPE).

3. A process as claimed in claim 1, wherein said thermoplastic elastomer (TPE) is santoprene®.

4. A process as claimed in claim 1, wherein said first layer (7) is at least partly formed out of said moulding cavity (2) and is inserted into said moulding cavity (2) when said mould (1a) and countermould (1b) are in a substantially open position.

5. A process as claimed in claim 4, wherein said first layer (7) is made in the form of a substantially flattened plate or sheet (7a) out of said moulding cavity (2) and wherein said plate (7a) is thermoformed, to take its final shape, by said injection-moulding of said second plastic material upon said first plastic material.

6. A process as claimed in claim 1, wherein said mould (1a) and countermould (1b) are arranged so as to be mutually movable in a plurality of moulding positions; wherein a first moulding position is set at which said moulding cavity (2) substantially has the sizes of said first layer (7); wherein said first plastic material is injection-moulded to form said first layer (7) directly in said moulding cavity (2) in said first position; wherein a second moulding position is set at which said moulding cavity (2) is extended relative to said first moulding position; and wherein said second plastic material is injection-moulded directly on said first plastic material.

7. A process as claimed in claim 6, wherein a third moulding position is set at which said moulding cavity (2) is further extended relative to said second moulding position, and wherein at said third moulding position a third layer (10) is injection moulded directly upon said second layer (8).

8. A process for making a membrane for fluid control apparatuses, comprising the steps of making at least one first layer (7) of a membrane (6) of a first plastic material chemically compatible with said fluid, making at least one second layer (8) of a second plastic material mainly defining the mechanical performance of said membrane, and making said layers integral with each other,
characterised in that it consists in: arranging at least one mould (1a) and one countermould (1b) mutually movable in a plurality of moulding positions; in setting a first moulding position at which said moulding cavity (2) substantially has the sizes of said first layer (7); in injection moulding said first plastic material to form said first layer (7) directly in said moulding cavity (2) at said first moulding position; in setting a second moulding position at which said moulding cavity (2) is extended relative to said first moulding position; and in injection moulding said second plastic material directly upon said first plastic material, to form one said second layer (8) directly joined to said first layer (7).

9. A process as claimed in claim 8, wherein a third moulding position is set at which said moulding cavity (2) is further extended with respect to said second moulding position and wherein in said third moulding position a third layer (10) is injection-moulded directly on said second layer (8).

10. A process as claimed in claim 8, wherein said first plastic material is selected from polyolefines, polyamides, polyesters, vinyl resins.

11. A process as claimed in claim 8, wherein said first plastic material is a polyolefine such as high density polyethylene (HDPE) with an ultra high molecular weight (UHMWPE).

12. A process as claimed in claim 8, wherein said second plastic material is a thermoplastic elastomer (TPE).

13. A process as claimed in claim 8, wherein said second plastic material is santoprene®.

14. A membrane for fluid-control apparatuses, comprising at least one first layer (7) of a first plastic material chemically compatible with said fluid, and at least one second layer (8) of a second plastic material mainly defining the mechanical performance of the membrane, said layers being integral with each other,
characterised in that said first plastic material is selected from polyolefines, polyamides, polyesters, vinyl resins, and in that said second plastic material is a thermoplastic elastomer (TPE) adapted to be injection-moulded and directly joined to said first plastic material.

15. A membrane as claimed in claim 14, wherein a third layer (10) is provided which is adapted to be injection-moulded and directly joined to said second layer (8), on the opposite side from said first layer (7).

16. A membrane as claimed in claim 15, wherein said third layer (10) is of the same plastic material as the material forming said first layer (7).

17. A membrane as claimed in claim 14, wherein said first plastic material is a polyolefine such as high density polyethylene (HDPE) with an ultra high molecular weight (UHMWPE).

18. A membrane as claimed in claim 14, wherein said thermoplastic elastomer (TPE) is selected from santoprene®, pebax®, hytrel®, finaprene®, elastollan®, pibiflex®.

19. A membrane as claimed in claim 14, wherein said thermoplastic elastomer (TPE) is santoprene®.
